(19) United States
(12) Patent Application Publication
(10) Pub. No.: US 2001/0046891 A1
(43) Pub. Date: Nov. 29, 2001

(54) Reverse keno

(76) Inventor: John Acres, City of Corvallis, OR (US)

Correspondence Address: PERKINS COIE LLP, PATENT-SEA, P.O. BOX 1247, SEATTLE, WA, 98111-1247, US

(21) Appl. No.: 09/847,040

(22) Filed: Apr. 30, 2001

Related U.S. Application Data
(60) Provisional application No. 60/200,947, filed on May 1, 2000.
(60) Provisional application No. 60/248,176, filed on Nov. 13, 2000.

(51) Int. Cl. G06F 17/00; A63F 13/00; A63F 9/24

(52) U.S. Cl. 463/18; 705/1

(57) ABSTRACT

A method and system for playing reverse keno. In one embodiment, the reverse keno system allows users to play reverse keno while they are visiting various web sites. The reverse keno system allows a user to select an initial set of numbers from a larger set of numbers. The reverse keno system then highlights the selected numbers on a reverse keno board, which may be very similar to a keno board. After the user selects the numbers, the reverse keno system then identifies a group of numbers from the numbers 1 to 80. The reverse keno system then removes the identified numbers on the reverse keno board. If any of the selected numbers have been removed, then the reverse keno game is over and the user may be awarded a consolation prize. If, however, all selected numbers remain, then the game continues. The reverse keno system then identifies and removes another set of numbers. If none of the identified numbers match the selected numbers (that is, all the selected numbers remain), then the game continues. The reverse keno system may determine whether a user should win based on probabilities that are independent of the number of numbers remaining and the number of selected numbers.

### CROSS-REFERENCE TO ALL RELATED APPLICATIONS

This application is related to U.S. patent application No. 60/200,947, entitled “METHOD AND SYSTEM FOR PLAYING A GAME,” filed on May 1, 2000 (Attorney Docket No. 336018003US); and U.S. patent application No. 60/248,176, entitled “REVERSE KENO WITH VIRTUAL ODDS,” filed on Nov. 13, 2000 (Attorney Docket No. 336018005US), the disclosures of which are incorporated herein by reference.

### TECHNICAL FIELD

The described technique relates to game playing.

### BACKGROUND

Because it facilitates electronic communications between vendors and purchasers, the Internet is increasingly being used to conduct “electronic commerce.” The Internet comprises a vast number of computers and computer networks that are interconnected through communication channels. Electronic commerce refers generally to commercial transactions that are at least partially conducted using the computer systems of the parties to the transactions. For example, a purchaser can use a personal computer to connect via the Internet to a vendor's computer. The purchaser can then interact with the vendor's computer to conduct the transaction. The World Wide Web portion of the Internet is especially conducive to conducting electronic commerce. Many web servers have been developed through which vendors can advertise and sell product through a web site. The products can include items (e.g., music) that are delivered electronically to the purchaser over the Internet and items (e.g., books) that are delivered through conventional distribution channels (e.g., a common carrier). A server computer system may provide an electronic version of a catalog that lists the items that are available. A user, who is a potential purchaser, may browse through the catalog using a browser and select various items that are to be purchased. When the user has completed selecting the items to be purchased, the server computer system then prompts the user for information to complete the ordering of the items. This order information may include the purchaser's name, the purchaser's credit card number, and a shipping address for the order. The server computer system then typically confirms the order by sending a confirming web page to the client computer system and schedules shipment of the items.

The profitability of an e-commerce web site depends in large part on the number of users who visit that web site. To encourage users to visit a web site, the web site may be advertised extensively. The web site may be advertised through traditional media, such as television, radio, and newspaper. The web site may also be advertised on web pages (e.g., via banner ads) generated by another web site. An advertiser may pay a displaying web site that displays their advertisement a certain amount each time that a user accesses a web page of the displaying web site that includes the advertisement. In addition, the advertiser may pay the displaying web site an additional amount each time a user clicks through the advertisement to access a web page of the advertised web site. Finally, the advertiser may pay the displaying web site a referral fee that is a percentage of the price of a purchase that resulted from the click through.

The displaying of advertisements can be very lucrative for a displaying web site. Indeed, some organizations may even pay users to browse the web while advertisements are displayed on a portion of user's display device. These organizations may collect demographic or other information about users so that the advertisements that are appropriate for each user can be selected. The organization may be compensated for each advertisement displayed, for each advertisement that is clicked through, and for each resulting transaction. Such organizations may also encourage users to refer friends and family to sign up with the organization. The referring user may be paid additional amounts if their referred friends and family browse the web while the organizations advertisements are displayed.

The compensation that a web site may receive for displaying an advertisement may be based in part on the perceived appropriateness of the advertisement to the user. For example, an advertisement for an automotive web site may not be appropriate for a ten-year old, but may be appropriate for a 21-year old. The advertisement for the automotive web site may be particularly appropriate to a 21-year old who has just purchased an automobile. Thus, an advertiser would be willing to pay more for advertisement whose appropriateness can be evaluated. Thus, to increase their revenues, organizations collect extensive information about users so that more appropriate advertisements can be presented to the users. The organizations may collect personal data such as age, occupation, gender, income, address, preferences, and shopping habits. These organizations may track the identity of a user using a sign on identification or a cookie stored on the user's computer. This information is so important that some organizations provide incentives (e.g., cash) for users to provide the information, which is then sold to other organizations.

Some web sites offer games (e.g., poker) that users can play to encourage users to visit the web site. As the users play the games, advertisements are displayed. Such gaming web sites may offer substantial prizes to encourage users to play the games and to provide personal information. These gaming web sites may even offer prizes to encourage users to click through the advertisements so that the gaming web site will receive a referral fee.

It would be desirable to have a new game in which users would enjoy playing and thus would visit a web site through which the game can be played.

### BRIEF DESCRIPTION OF THE DRAWINGS

FIG. 1 illustrates the display of the reverse keno board.

FIG. 2 is a table that illustrates the various awards as reverse keno is played.

FIG. 3 is a block diagram illustrating virtual probability tables in one embodiment.

FIG. 4 illustrates a sample electronic mail message used to encourage a person to play during a certain time.

FIG. 5 is a block diagram illustrating display of a web page in which the prize is a based on the web site visited.

FIG. 6 is a block diagram illustrating tables used by the reverse keno system to select a prize based on the side visited.

FIG. 7 is a block diagram illustrating components used to implement the reverse keno system in one embodiment.

FIG. 8 is a flow diagram illustrating the playing of reverse keno.

FIG. 9 is a flow diagram illustrating a routine for selecting spots using virtual probabilities.

FIG. 10 is a flow diagram illustrating processing of routine for selecting a prize based on the Web site visited.

### DETAILED DESCRIPTION

A method and system for playing reverse keno is provided. In one embodiment, the reverse keno system allows users to play reverse keno while they are visiting various web sites. (Reverse keno can, however, be played independently of the Internet and independently of any computer system.) The reverse keno system allows a user to select an initial set of numbers from a larger set of numbers. For example, a user may initially select 7 numbers from the numbers 1 to 80. The reverse keno system then displays the selected numbers on a reverse keno board, which may be very similar to a keno board. The reverse keno system may indicate which numbers are selected by the user by displaying those numbers in a certain color (e.g., red). After the user selects the numbers, the reverse keno system then identifies a group of numbers from the numbers 1 to 80. Numbers are also referred to as “spots.” The reverse keno system then indicates the identified numbers on the reverse keno board. These identified numbers may be considered to be removed. These identified numbers may be indicated in a color that is different from the color used to indicate the numbers selected by the user or may be overlaid by an “X.” If any of the selected numbers have been removed, then the reverse keno game is over and the user may be awarded a consolation prize. If, however, all selected numbers remain, then the game continues. The reverse keno system then identifies and displays another set of numbers. If none of the identified numbers match the selected numbers (that is, all the selected numbers remain), then the game continues. The process of identifying spots and comparing to the selected numbers is referred to as a “level” of the game. At each level, the reverse keno system may ask the user whether they want to continue playing. If the user does not want to continue playing, then the reverse keno system awards a prize to the user based on the number of spots that have been identified. If the user wants to continue playing, then the potential prize is increased. If the reverse keno system does find a match (i.e., a selected number is removed), then it may award a consolation prize to the player.

In an alternate embodiment, the player is not given a chance to stop or continue after each level, rather the game continues to the next level until a selected number is removed. When a selected number is removed, the player is awarded a prize based on the current level. The game may end at that point or may continue onto another aspect of the game known as a final round. In the final round, the user is given an opportunity to win the award, lose the award, or win an enhanced award. For example, a grid of numbers may be displayed with numbers being assigned to win the award, lose the award, or win the enhanced award. The assignments may be indicated by different colors. The system then selects (e.g., randomly) one of the numbers and displays the number to the user. If the selected number matches a number assigned to win the award, then the user wins the current award. If the selected number matches a number assigned to lose the award, then the user does not win the current award. If the selected number matches a number assigned win the enhanced award, then the user wins an enhanced award (e.g., 100 times the current award). The game then ends. The odds of winning in the final round can be varied by the assignment of more or less numbers to the win, lose, or enhanced win categories.

In the following, one embodiment of reverse keno, called oneK, is described. The game works like keno in reverse, hence the name. A player plays reverse keno by first selecting 7 numbers. An 80 number grid then appears, which is much like the traditional game of keno. In reverse keno though, the game begins with all 80 numbers showing. One by one, spots are removed. A player wins if all 7 of the selected numbers are within the remaining spots.

The prize for the first level includes credits which may be redeemed for cash, merchandise or additional free games. Each credit has a nominal value of about 1-cent. The first award opportunity is offered after 8 of the 80 spots have been removed (72 spots remain). If all 7 of the selected numbers are still showing, an award of 10 credits is offered (about half of all games played will win this first level award). The player then chooses to take the 10 credits or risk them for a larger award.

Presuming the player keeps playing, 10 more spots are taken away at the second level leaving 62. If any of the selected 7 numbers are among those removed, the game is over and the player has won nothing. If the 7 selected numbers remain, the player has won 20 credits (about 1 player in 3 that won the first round will also win the second). Again, the player can collect and end the game or risk all 20 credits for a chance to win more. Another 10 spots are removed at the third level. If all of the selected numbers remain, the player has won 50 credits which the player can keep or risk to win 300.

The award at the fourth level is 1,000 credits and $20 cash (32 spots remain) and it is the player's last all-or-nothing hurdle. Presuming the player is an eligible “member,” the player is guaranteed consolation prizes of half the cash risked.

At the next level (22 spots remain), the award is $300 if the player wins and $10 (plus 1,000 credits if the player loses). There remain 7 levels (17, 13, 12, 11, 10, 9 and 8 spots remaining) to achieve with cash prizes of $3,000, $30,000, $100,000, $200,000, $500,000, $2,000,000 and finally the $15 million plus progressive jackpot.

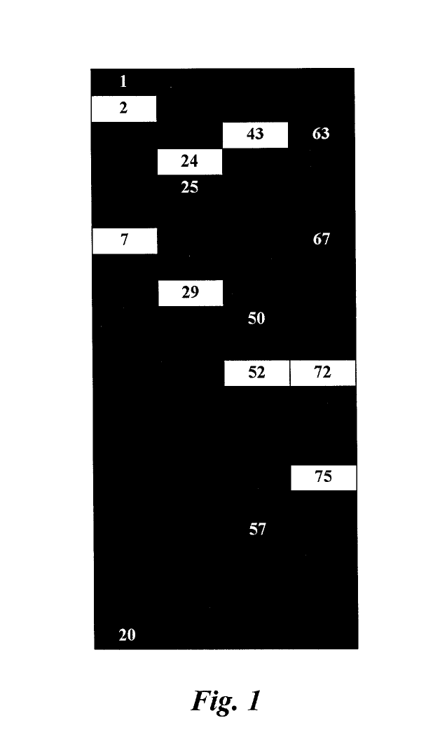

FIG. 1 illustrates the display of the reverse keno board. This reverse keno board may be displayed alongside and advertiser's web page and the reverse keno game may be played while the user views the web page. In this displayed example, the player selected the numbers that are in white (1, 20, 25, 50, 57, 63, and 67). The identified spots are shown in black on white. In this example, eight numbers have been identified (2, 7, 24, 29, 43, 62, 72, and 75). The player already has 10 credits and needs to decide whether to keep the credits or to wager them to try to win more. If the player decides to wager, 10 more numbers are identified. The reverse keno board may take on various different shapes and labeling. In addition, the various selected numbers and identified numbers may be shown in different ways. For example, the board may initially display all 80 numbers with the select numbers in a different color. The reverse keno system may then remove the numbers as they are identified. If a selected number is identified, it may be displayed in a flashing mode to notify the player that the game is over.

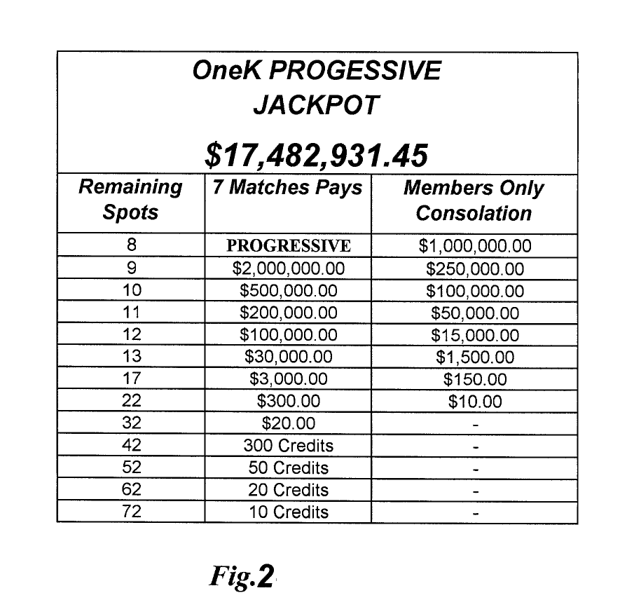

FIG. 2 is a table that illustrates the various awards as reverse keno is played. As the number of spots remaining decreases, the size of the prize increases. In this example, if 22 spots remain and all seven of the selected numbers remain, then the reverse keno system awards a prize of $300. One skilled in the art would appreciate that the levels can be set at different numbers of remaining spots and that those shown are merely exemplary. In addition, reverse keno can be played with any number of numbers or, more generally, items. For example, an item can be a letter (e.g., “A,” “B”), or any other unique symbol such as a shape.

The probability of removing one of the selected numbers at a level is based on the number of selected numbers, the number of identified spots and the number of remaining spots. For example, if 1 number is selected, if 10 spots are identified, and if 80 spots remain, then the probability that the selected number will be removed is approximately 12 percent (e.g., 10/80). In one embodiment, the reverse keno system allows the probability of removing a selected number at a level to be independent of the number of selected numbers, the number of identified numbers, and the number of remaining numbers. Because of this independence, the probabilities are referred to as “virtual probabilities” or “virtual odds.” The reverse keno system may assign a probability to each level. The reverse keno system determines whether the player will either win or lose at that level based on the probability associated with that level. For example, if the probability at the first level is 75 percent, then the reverse keno system will determine that the player will win 75 percent of the time at that level. When the reverse keno system determines that a player will win at that level, then the system identifies the numbers to remove from a group of the remaining numbers so that the group does not include any number selected by the player. When the reverse keno system determines that a player will lose at that level, then the system includes in the group to remove at least one of the numbers selected by the player. One skilled in the art will appreciate that virtual probabilities can be used with many different games, such as keno itself. For example, prior to picking numbers, a keno system can determine whether the player will win or lose based on a virtual probability and then pick numbers to affect the determined outcome.

In one embodiment, the reverse keno system uses a table of probabilities that includes a probability of winning for each level. To determine whether a player is to win or lose, the reverse keno system retrieves the probability for the current level from the probability table. The reverse keno system then randomly selects a probability (e.g., a random number between 0 and 1). If the randomly selected probability is less than or equal to the retrieved probability, then the system determines that the player has won at that level. The reverse keno system may use different tables of probabilities based on various conditions. For example, the reverse keno system may use different tables of probabilities during peak and non-peak operating hours. The table of probabilities for the non-peak operating hours may include a higher probability of winning at at least one level to encourage players to play during non-peak operating hours. Different probabilities can be used to encourage playing reverse keno under various conditions. For example, the probabilities can be based on demographic information of the player (e.g., age, gender, or occupation) to encourage players with certain characteristics to play reverse keno. In addition, the reverse keno system may give players with certain characteristics an increased probability of winning based on the type of web site visited while playing reverse keno. For example, the reverse keno system may give a 21-year old who just purchased an automobile an increased probability of winning when the 21-year old plays reverse keno while visiting an automotive web site. The reverse keno system may also award prizes based on the probability of winning at a certain level. For example, although the probability of winning at a certain level may be increased, the actual value of the prize for winning at that level may be correspondingly decreased.

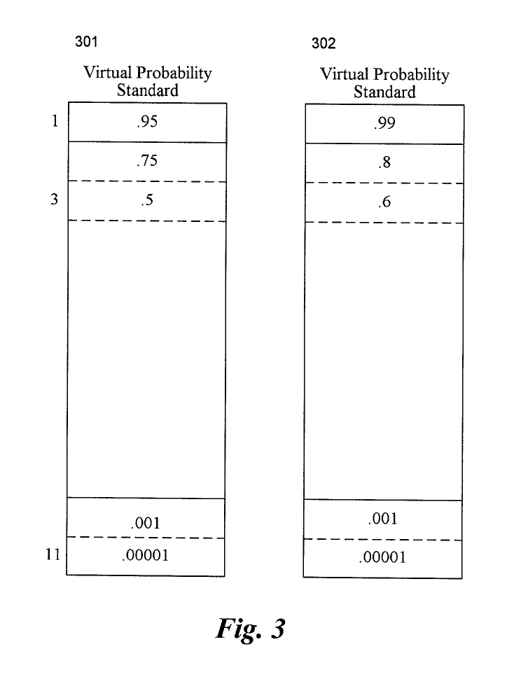

FIG. 3 is a block diagram illustrating virtual probability tables in one embodiment. Virtual probability table 301 contains the standard probabilities of winning, and virtual probability table 302 contains the enhanced probabilities of winning. As indicated by these tables, the standard probability of winning at the first level is 0.95, and the enhanced probability of winning at the first level is 0.99. In this example, the probability of winning is reduced at each succeeding level. To determine whether a player is to win at the third level when using the enhanced probability table, the reverse keno system randomly selects a probability, for example, 0.7. Since the probability in the enhanced probability table for the third level is 0.6, the reverse keno system will determine that the player will lose at the third level because 0.7 is greater than 0.6. If, however, the randomly selected probability was 0.3, then the reverse keno system would determine that the player would win at the third level because 0.3 is less than 0.6.

In another embodiment, the reverse keno system encourages players to play under certain conditions, such as non-peak operating hours. When users are encouraged to play during non-peak operating hours, the overall capacity of the reverse keno system is more fully utilized. The reverse keno system may notify a player that they will receive an enhanced benefit (e.g., better probabilities of winning or enhanced prizes) when they play the game under the certain conditions. The notification may be an electronic mail message, a voice message, and so on. In addition, the reverse keno system may include an advertisement in the notification to further increase revenue. The offering of the enhanced benefits may increase the chances that the recipient of the notification will actually read the notification (e.g., electronic mail message) and click through an advertisement. The reverse keno system may provide a winning hint along with the notification. For example, the notification may indicate that the player will receive an enhanced benefit if the number “7” is played between 6 and 8 AM. The certain conditions for enhanced benefits may include the visiting of a certain web site or categories of web sites. For example, the reverse keno system may notify a 21-year old who just purchased an automobile that an enhanced benefit will be provided when that 21-year-old visits an automotive web site.

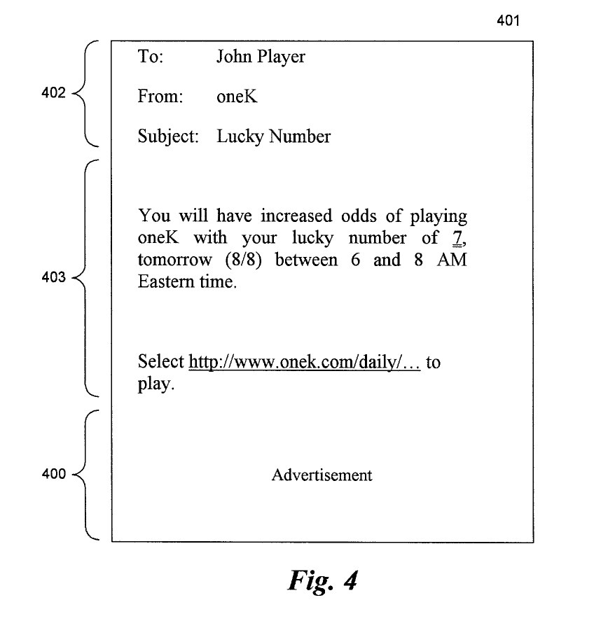

FIG. 4 illustrates a sample electronic mail message used to encourage a person to play during a certain time. The electronic mail message 401 includes an identification area 402 and a hint area 403. The hint area indicates that the player will have increased odds of playing reverse keno when they select the number of “7” between 6 and 8 AM on the following day. In addition, the hint area includes a link to a web site at which reverse keno can be played. The link may include a code to indicate that the player is entitled to the increased odds. Alternatively, the reverse keno system may store the information necessary to increase the probability when that player plays during 6 and 8 AM. The reverse keno system may use cookies stored on the player's computer to identify the player. The electronic mail message may also include an advertisement area 404. The reverse keno system may send the message so that it is timed to arrive between 6 and 8 AM.

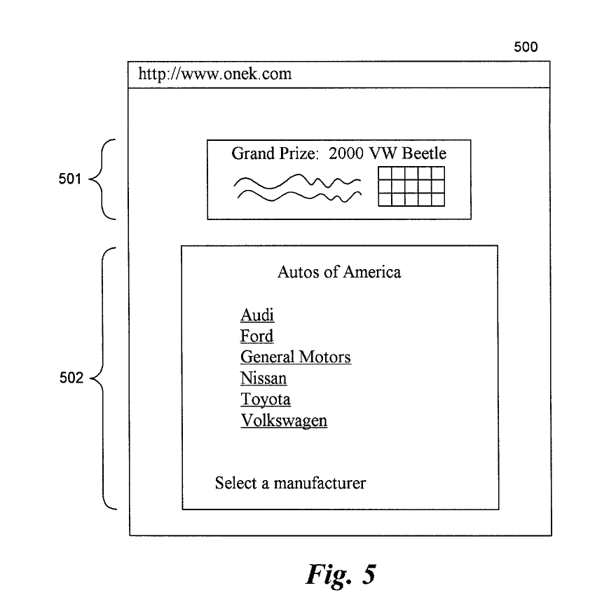

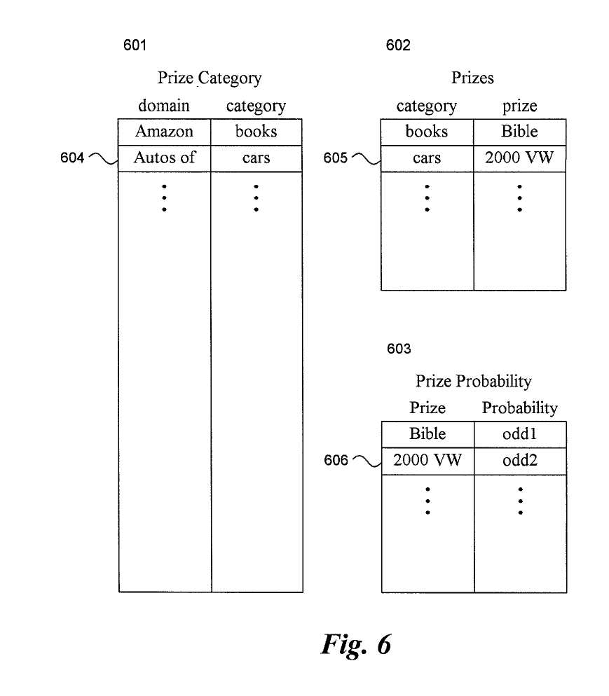

In one embodiment, the reverse keno system awards prizes, including consolation prizes, based on characteristics of the player. The reverse keno system may award a prize based on the web site currently being visited by the player, demographics of the player, historical web site access patterns of the player, past purchases of the player, preferences identified by the player, and so on. For example, the player who is currently visiting, or often visits, an automotive web site may receive an automotive-related consolation prize. FIG. 5 is a block diagram illustrating the display of a web page in which the prize is a based on the web site visited. Web page 500 includes a game area 501 and a web site area 502. The player may visit the reverse keno web site to start playing the game. The player may also indicate the web site to be visited while the game is being play. The reverse keno system then displays the game area along with the web page from the indicated web site in web site area. The web site area may be implemented as a separate frame from the game area. In this example, the grand prize for winning the game is a Volkswagen beetle, and the web site visited is “Autos of America,” which describe automobiles available in the United States. The reverse keno system selected the grand prize of an automobile because the web site visited was automotive related. FIG. 6 is a block diagram illustrating tables used by the reverse keno system to select a prize based on the web site visited. The reverse keno system uses a prize category table 601, a prizes table 602, and a prize probability table 603. The prize category table maps various web domains to associated categories. For example, the “Autos of America” domain is mapped to the “cars” category as indicated by entry 604. The prizes table maps prize categories to the current grand prize to be awarded in that category. For example, the “cars” category has a Volkswagen beetle prize associated with it as indicated by entry 605. Each prize category may also have prizes for each level identified. The prize probability table maps various prizes to the probability table to be used when offering that prize. For example, when the Volkswagen beetle is offered, then a probability table identified as “odd2” is used to determine the probabilities when playing reverse keno as indicated by entry 606.

A computer-based referral method and system is also provided to encourage people to play the games, such as keno or reverse keno, at a casino. The referral system awards benefits to those people who refer other people to play games at a casino. When the referred person plays a game at the casino, the referral system awards a benefit to the referring person. The benefits awarded can take many forms, such as a percentage of the amount of money wagered by or lost by the referred person. The referral system receives the identification of the referred person when the game is to be played. The referred person may identify the referring person at that time, or the referral system may maintain a table of mappings between referred persons and referring persons. The referral system then tracks the games played by the referred person and related statistics such as money wagered, money lost, and money won. If the referred person is playing the slot machines, then the referred person may have a magnetic identification card that is inserted into the slot machine at the start of play. In this way, the referred person is identified to the referral system. The referral system then tracks the activity at that slot machine until the magnetic identification card is removed. The insertion and removal of the identification card may delimit a game playing “session.” When the session is complete, the referral system stores the characteristics of the session for awarding the benefit to the referring person.

A consumer's value to advertisers is enhanced when a personal profile is available for each individual. With this detail, each consumer can be matched to advertisers within their range of interest, which makes the experience more enjoyable for the consumer and more cost-effective for the advertiser. In addition, advertisers will likely pay more for each visit if they are confident that the consumer has an interest in their product.

The reverse keno system may offer membership to each player who completes a personal profile. For security purposes, all players may be requested provide name and address data and establish a password to play the game.

By taking a few moments to complete the survey, players become eligible for consolation prizes on all cash awards. Consolation prizes make it much easier for players to gamble on winning a larger prize. Instead of the all-or-nothing proposition offered to nonmembers, eligible members are given an award equal to half of their original prize even if they try for the next level of prize and fail. For example, a user who has played reverse keno for several months and tonight has been lucky enough to win $300 can keep the award or risk it and try for $3,000. Non-members end up with nothing if their gamble fails. As a member, the user gets a consolation prize of $150, which takes much of the sting out of the loss.

To be eligible, a user first completes the user profile. But a user may also be required to visit regularly. If it has been more than, for example, 72 hours since the user's last game, the user is not eligible to win consolation prizes. If the user loses eligibility, the user can automatically recover it by playing a second session within the 72-hour time.

The reverse keno system encourages members to recruit new members by offering a multi-level series of incentives. If a member sponsors someone else to become a member, then that sponsoring member may be eligible to win 20% of any cash awards that new member wins. If that new member recruits other members and they win, in the sponsoring member may get 5% of their winnings. Each winner gets a full payment of the advertised awards—incentives are simply paid as additional bonuses.

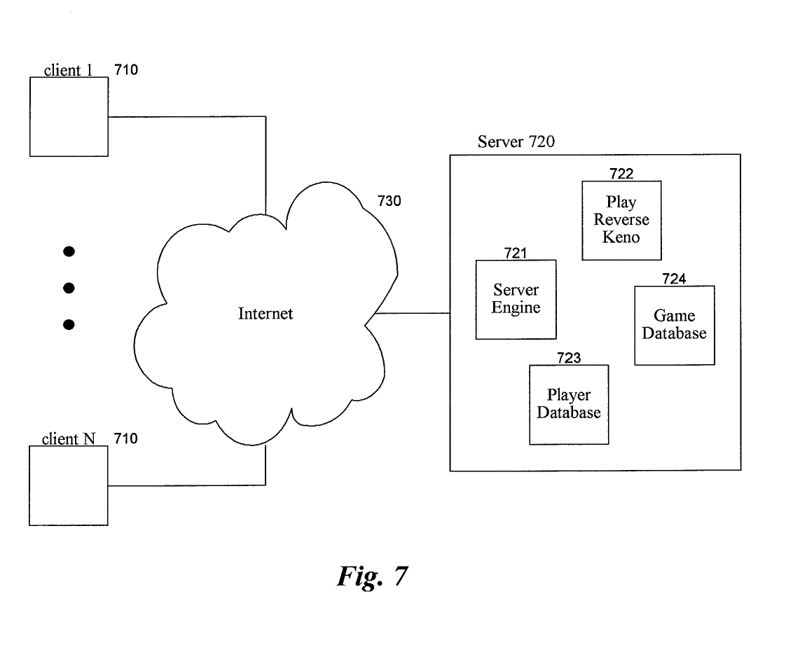

FIG. 7 is a block diagram illustrating components used to implement the reverse keno system in one embodiment. The client computers 710 and the reverse keno server computer 720 are interconnected via the Internet 730. The computers may include a central processing unit, memory, input devices (e.g., keyboard and pointing devices), output devices (e.g., display devices), and storage devices (e.g., disk drives). The memory and storage devices are computer-readable media that may contain instructions that implement the advertisement system. In addition, the data structures and message structures may be stored or transmitted via a data transmission medium, such as a signal on a communications link. Various communications channels other than the Internet may be used, such as a local area network, a wide area network, or a point-to-point dial-up connection. The reverse keno server 720 includes a server engine 721, the reverse keno game program 722, an player database 723, and a game database 724. The server engine receives HTTP requests and coordinates the sending of the HTTP response messages corresponding to the displays of reverse keno. The player database contains information relating to each user who is registered to play reverse keno. The game database contains information describing the current state of the games being played by the users.

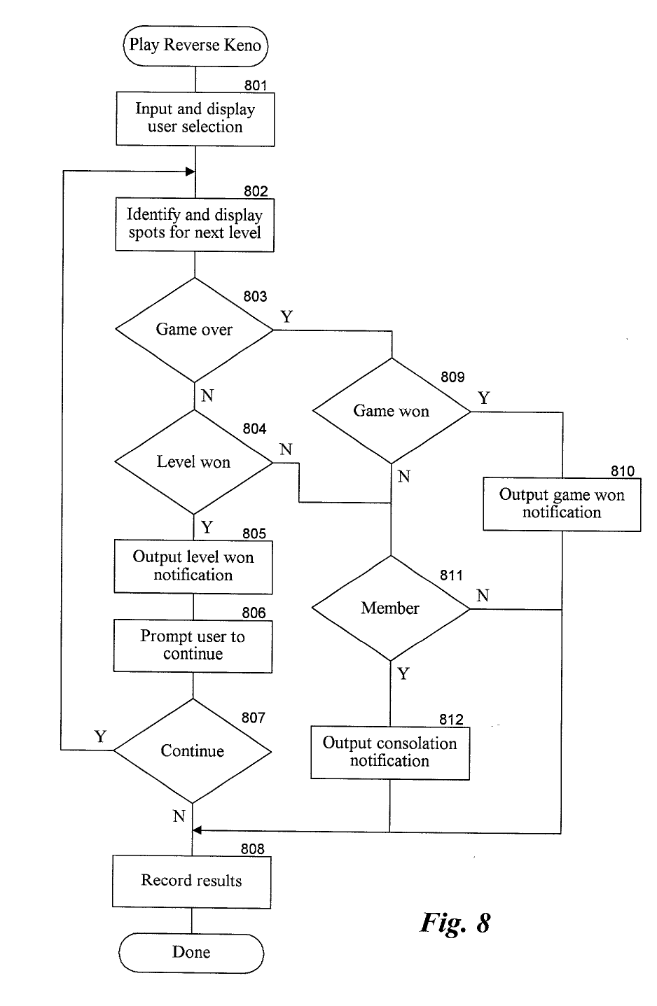

FIG. 8 is a flow diagram illustrating the playing of reverse keno. Reverse keno may be played manually or may be played under the control of a computer. In block 801, the system inputs and displays the user's selection of the numbers. In blocks 802-407, the system loops playing each level of the game. In block 802, the system identifies and displays the spots that are to be removed for the next level. In decision block 803, if the game is over (e.g., the last level has been played and the selected numbers still remain), then the system continues at block 809, else the system continues at block 804. In decision block 804, if the user has won the current level (e.g., the selected numbers still remain), then the system continues at block 805, else the system continues at block 811. In block 805, the system outputs a level won notification and indicates the spots that have been removed. In block 806, the system asks the user whether they want to continue playing or take the award for that level. In decision block 807, if the user wants to continue, the system loops to block 802 to select the next level, else the system continues at block 808. In block 808, the system records the results and completes. In decision block 809, if the game has been won, then the system continues at block 810, else the system continues at block 811. In block 810, the system outputs a game won notification and then continues at block 808. In decision block 811, if the user is a member, then the system continues at block 812, else the system continues at block 808. In block 812, the system output an indication of the consolation prize that the member has won and then continues at block 808.

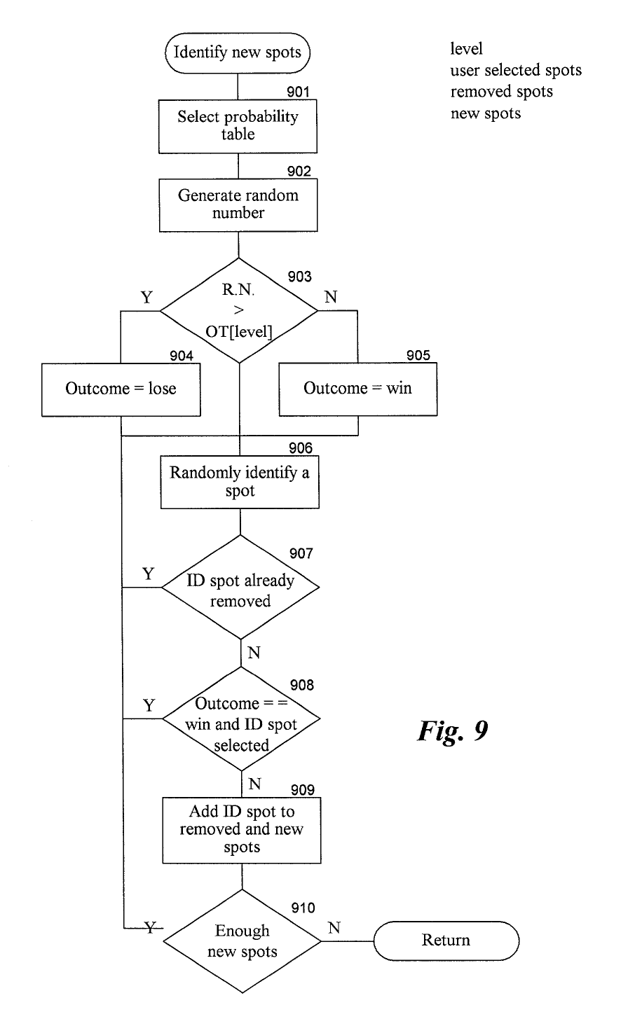

FIG. 9 is a flow diagram illustrating an example routine for selecting spots using virtual probabilities. This routine may be passed an indication of the current level, an indication of the currently selected numbers, and an indication of the removed numbers. The routine identifies new numbers and returns them. In block 901, the routine selects a probability table. The probability table may be selected based on various characteristics as discussed above. In block 902, the routine selects a randomly generated probability, which is a number between 0 and 1. In decision block 903, if the randomly generated probability is greater than the probability at the passed level, then the routine sets the outcome to lose in block 904, else the routine sets the outcome to win in block 905. In blocks 906-910, the routine loops identifying random numbers to be removed to effect the desired outcome. In block 906, the routine identifies a random number. In decision block 907, if the identified number is already removed, then the routine loops to identify another number in block 906, else the routine continues at block 908. In decision block 908, if the outcome is to win and the identified number is the same as one of the numbers selected by the player, then the routine loops to block 906 to identify another number, else the routine continues to block 909. In block 909, the routine adds the identified number to the list of newly identified numbers and to the list of already removed numbers. In decision block 910, if enough new numbers have already been selected, then the routine returns, else the routine loops to block 906 to identify another number.

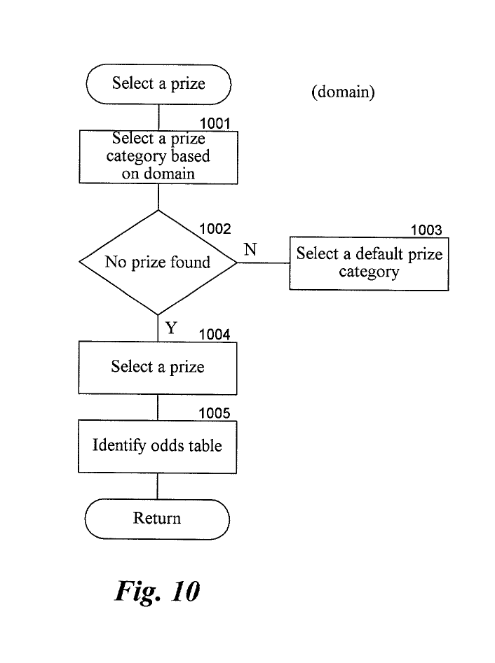

FIG. 10 is a flow diagram illustrating processing of an example routine for selecting a prize based on the web site visited. The routine is passed an indication of the domain of the web site and returns an indication of the selected prize. In block 1001, the routine selects a prize category based on the passed domain using the prize category table. In decision block 1002, if no prize category was found for the passed domain, then the routine selects a default prize category in block 1003. In block 1004, the routine selects a prize based on the selected prize category from the prize table. In block 1005, the routine identifies the probability table to use for the selected prize. The routine then returns.

From the foregoing it will be appreciated that although specific embodiments of the game have been described herein for purposes of illustration, various modifications may be made without deviating from the spirit and scope of the invention. Accordingly, the invention is not limited except by the appended claims.

1. A method of playing a game, comprising:
receiving a selection of target items selected from a plurality of items;
identifying a subset of the plurality of items;
determining whether the target items contain any item in common with the identified subset of items; and
when it is determined that the target items contain no item in common with the identified subset of items, indicating success at the game.

2. The method of claim 1 wherein when success is indicated, identifying a subset of the plurality of items such that previously identified items are not identified again and then repeating the determining.

3. The method of claim 2 wherein when it is determined that the target items contain an item in common with the identified subset of items, indicating lack of success at the game.

4. The method of claim 3 wherein an award is made based on previously indicated success at the game.

5. The method of claim 1 wherein when success is indicated, receiving input as to whether the game should continue.

6. The method of claim 5 wherein when it is indicated that the game should continue, identifying a subset of the plurality of items such that previously identified items are not identified again and then repeating the determining.

7. The method of claim 1 wherein a player of the game is given an option to continue with identifying items.

8. The method of claim 1 wherein the game is reverse keno.

9. The method of claim 1 wherein a computer coordinates the playing of the game.

10. The method of claim 1 wherein the success at the game is determined using virtual odds.

11. The method of claim 1 wherein when it is determined that the target items contain an item in common with the identified subset of items, indicating lack of success at the game and continuing with a final round of the game.

12. The method of claim 11 wherein the final round includes selecting a number and based on the selected number awarding a prize, not awarding a prize, or awarding an enhanced prize.

13. A method in a computer system for playing a game, comprising:
receiving a selection of target numbers from a plurality of numbers; and
while lack of success is not indicated,
identifying numbers from a plurality of numbers that have not been previously identified; and
when any target number is the same as an identified number, indicating lack of success.

14. The method of claim 13 wherein when no target number is the same as an identified number, receiving input as to whether the game should continue.

15. The method of claim 14 wherein when the received input indicates that the game should not continue, awarding a prize based on the number of identified numbers.

16. The method of claim 13 wherein when lack of success is indicated, awarding a consolation prize based on the number of identified numbers.

17. The method of claim 13 including when a certain number of identified numbers have been identified without indicating lack of success, indicating that the game is over.

18. The method of claim 13 wherein the game is reverse keno.

19. The method of claim 13 wherein the game is played using virtual odds to determine an outcome of the game.

20. A computer-readable medium containing instructions for controlling a computer system to play a game, by a method comprising:
receiving a selection of target items selected from a plurality of items;
identifying a subset of the plurality of items; and
when the target items contain no item in common with the identified subset of items, indicating success at the game.

21. The computer-readable medium of claim 20 wherein when success is indicated, identifying a subset of the plurality of items such that previously identified items are not identified again and then repeating indicating success at the game when the target items contain no item in common with the newly identified subset of items.

22. The computer-readable medium of claim 20 wherein when the target items contain an item in common with the identified subset of items, indicating lack of success at the game.

23. The computer-readable medium of claim 22 wherein an award is made based on previously indicated success at the game.

24. The computer-readable medium of claim 20 wherein when success is indicated, receiving input as to whether the game should continue.

25. The computer-readable medium of claim 24 wherein when it is indicated that the game should continue, identifying a subset of the plurality of items such that previously identified items are not identified again and then repeating indicating success at the game when the target items contain no item in common with the newly identified subset of items.

26. The computer-readable medium of claim 20 wherein a player of the game is given an option to continue with identifying items.

27. The computer-readable medium of claim 20 wherein the game is reverse keno.

28. The computer-readable medium of claim 20 wherein the success at the game is determined using virtual odds.

29. The computer-readable medium of claim 20 wherein when the target items contain an item in common with the identified subset of items, indicating lack of success at the game and continuing with a final round of the game.

30. The computer-readable medium of claim 29 wherein the final round includes selecting a number and based on the selected number awarding a prize, not awarding a prize, or awarding an enhanced prize.

31. A computer system for playing a game, comprising:
means for receiving a selection of target items selected from a plurality of items;
means for identifying a subset of the plurality of items; and
means for indicating success at the game when the target items contain no item in common with the identified subset of items.

32. The computer system of claim 31 including means for identifying a subset of the plurality of items such that previously identified items are not identified again when success is indicated and means for indicating success at the game when the target items contain no item in common with the newly identified subset of items.

33. The computer system of claim 31 including means for indicating lack of success at the game when the target items contain an item in common with the identified subset of items.

34. The computer system of claim 33 wherein an award is made based on previously indicated success at the game.

35. The computer system of claim 31 including means for receiving input as to whether the game should continue when success is indicated.

36. The computer system of claim 35 including means for identifying a subset of the plurality of items such that previously identified items are not identified again when it is indicated that the game should continue and means for indicating success at the game when the target items contain no item in common with the newly identified subset of items.

37. The computer system of claim 31 including means for giving a player of the game an option to continue with identifying items.

38. The computer system of claim 31 wherein the game is reverse keno.

39. The computer system of claim 31 including means for determining success at the game using virtual odds.

40. The computer system of claim 31 including means for indicating lack of success at the game and means for continuing with a final round of the game when the target items contain an item in common with the identified subset of items.

41. The computer system of claim 40 wherein the means for continuing with the final round selects a number and based on the selected number awards a prize, does not award a prize, or awards an enhanced prize.

42. A computer-readable medium containing instructions for controlling a computer system to coordinate playing a game, by a method comprising:
receiving a selection of target numbers from a plurality of numbers; and
while success is indicated,
identifying numbers from the plurality of numbers that have not been previously identified; and
when no target number is the same as an identified number, indicating success.

43. The computer-readable medium of claim 42 including receiving input as to whether the game should continue.

44. The computer-readable medium of claim 43 wherein when the received input indicates that the game should not continue, awarding a prize based on the number of identified numbers.

45. The computer-readable medium of claim 42 wherein when success is not indicated, awarding a consolation prize based on the number of identified numbers.

46. The computer-readable medium of claim 42 including when a certain number of identified numbers have been identified while success is indicated, indicating that the game is over.

47. The computer-readable medium of claim 42 wherein the game is reverse keno.

48. The computer-readable medium of claim 42 wherein the game is played using virtual odds to determine an outcome of the game.

49. A method of playing a game, comprising:
selecting target items from a plurality of items;
receiving an indication of an identified subset of the plurality of items; and
when the target items contain no item in common with the identified subset of items, receiving an indication of success at the game.

50. The method of claim 49 wherein when success is indicated, receiving an indication of an identified subset of the plurality of items such that previously identified items are not identified again and receiving an indication of success at the game when the target items contain no item in common with the newly identified subset of items.

51. The method of claim 49 wherein when it is determined that the target items contain an item in common with the identified subset of items, indicating lack of success at the game.

52. The method of claim 51 wherein an award is made based on previously indicated success at the game.

53. The method of claim 49 wherein when success is indicated, receiving input as to whether the game should continue.

54. The method of claim 49 including receiving an indication that a player of the game is to continue with identifying items.

55. The method of claim 49 wherein the game is reverse keno.

56. The method of claim 49 wherein when the target items contain an item in common with the identified subset of items, indicating lack of success at the game and continuing with a final round of the game.

57. The method of claim 56 wherein the final round selects a number and based on the selected number awarding a prize, not awarding a prize, or awarding an enhanced prize.
